(19) United States
(12) Patent Application Publication
(10) Pub. No.: US 2011/0310263 A1
(43) Pub. Date: Dec. 22, 2011

(54) IMAGE RESOLUTION ADJUSTING METHOD

(75) Inventor: Hsiu Hung Pien, Hsinchu City (TW)

(73) Assignee: ALTEK CORPORATION, Hsinchu (TW)

(21) Appl. No.: 12/818,838

(22) Filed: Jun. 18, 2010

(51) Int. Cl. H04N 5/228

(52) U.S. Cl. 348/222.1; 348/E05.031

(57) ABSTRACT

An image resolution adjusting method is applicable to an image capturing device, such that the image capturing device can analyze an image quality of the captured image and determine a resolution for storing a captured image according to a blur degree of the captured image. Therefore, it can make use of storage resources effectively.

### BACKGROUND OF THE INVENTION

1. Field of Invention

The present invention relates to an image processing method, and more particularly to an image resolution adjusting method.

2. Related Art

With the rapid development of digital cameras, photography is no longer an expensive entertainment. A user is enabled to take any desirable picture at will, so as to record a memorizable moment or image.

When taking pictures, the user normally expects that the obtained pictures are clear. Thus, when taking pictures of a target (including scenery, human, or article), the user needs to adjust a focal length and a brightness for the target properly, so as to obtain satisfactory pictures.

With the progress of technologies, most digital cameras are provided with the function of automatic setting of shooting parameters. Generally, the digital camera calculates proper shooting parameters for a specific target.

Considering the resolution of the captured image, the user is required to adjust the resolution independently through a relevant menu provided on the digital camera before capturing an image.

If the user does not alter the resolution setting, the images captured for various occasions, topics, and main characters all have the same resolution.

Since the digital camera has a limited storage space, when the resolution is set at a higher level, the number of images that can be captured is reduced. In addition, after the images are sorted later, the user usually finds that many pictures that are hardly worth using but not bad enough to throw away are kept to occupy storage resources, for example, a memory card in the digital camera, a hard disc on a computer, a burnt optical disc, or a personal photo album on the network.

On the contrary, if a lower resolution is selected to save the storage space, details of certain wonderful images are sacrificed.

If the highest resolution is selected to record as many details as possible, pictures with subordinate, poor, or extremely poor quality may less valuably or least valuably occupy the space of the storage medium of the camera, which greatly influences the number of pictures that can be taken.

### SUMMARY OF THE INVENTION

In view of the above problems, the present invention is an image resolution adjusting method, which solves one or more problems in the prior art.

The present invention provides an image resolution adjusting method, which is applicable to an image capturing device.

The image capturing device comprises a camera module and a storage unit.

First, the camera module captures an image with a first resolution, and analyzes a blur degree of the captured image.

Then, the analyzed blur degree is compared with a threshold value. When the blur degree exceeds the threshold value, the resolution of the image is lowered from the first resolution to a second resolution, and the image with the second resolution is stored in the storage unit. When the blur degree does not exceed the threshold value, the image with the first resolution is stored in the storage unit.

The present invention further provides an image resolution adjusting method, which is applicable to an image capturing device. The image capturing device comprises a camera module and a storage unit.

First, the camera module captures an image with a first resolution, and analyzes a blur degree of the captured image.

Then, relation information is searched by using the analyzed blur degree. The relation information comprises a first blur range, at least one second blur range different from one another, and resolution adjusting data respectively corresponding to the first blur range and the second blur range.

When the blur degree is in the first blur range, the image with the first resolution is stored in the storage unit according to the resolution adjusting data corresponding to the first blur range. When the blur degree is in one of the second blur ranges, the resolution of the image is lowered from the first resolution to the second resolution according to the resolution adjusting data corresponding to the second blur range, and the image with the second resolution is stored in the storage unit.

Here, the blur degree of the image is calculated through a blur detection procedure.

The image resolution adjusting method according to the present invention is applicable to an image capturing device, which determines a resolution for storing a captured image by analyzing an image quality of the captured image, so as to make use of storage resources effectively.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an image capturing device;

FIG. 2 is a flow chart of an image resolution adjusting method according to a first embodiment of the present invention;

FIG. 3 is a flow chart of an image resolution adjusting method according to a second embodiment of the present invention; and

FIG. 4 is a flow chart of an image resolution adjusting method according to a third embodiment of the present invention.

### DETAILED DESCRIPTION OF THE INVENTION

An image resolution adjusting method according to the present invention is applicable to an image capturing device, which determines a resolution for storing a captured image by analyzing an image quality of the captured image, so as to make use of storage resources effectively. The image capturing device may be a digital camera, a digital video camera, or an electronic device with a camera module (for example, a mobile phone or a computer).

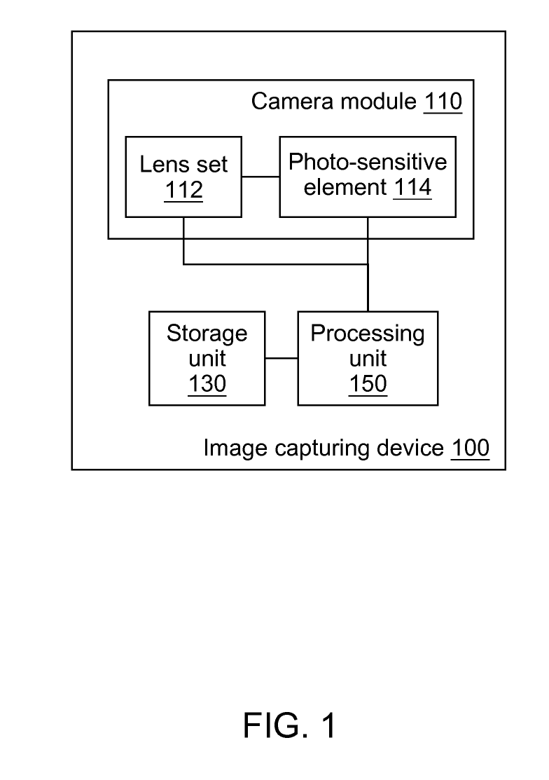

Referring to FIG. 1, an image capturing device 100 comprises a camera module 110, a storage unit 130, and a processing unit 150. The camera module 110 comprises a lens set 112 and a photo-sensitive element 114.

The lens set 112 is used for adjusting a focal length for a shot object.

The photo-sensitive element 114 is set corresponding to the lens set 112. The photo-sensitive element 114 receives an optical signal corresponding to a target and scenery around through the lens set 112, and converts the received optical signal into an electrical signal of a digital image, so as to obtain an image corresponding to the target. In other words, the photo-sensitive element 114 captures an image of a view-finding picture via the lens set 112.

The processing unit 150 is electrically connected to the photo-sensitive element 114 and the storage unit 130. The processing unit 150 controls operations of the lens set 112 and the photo-sensitive element 114 and stores the captured image in the storage unit 130.

Before storing the captured image, the processing unit 150 analyzes a quality of the captured image and selectively adjusts a resolution of the captured image according to the quality of the captured image.

In other words, the image resolution adjusting method according to the present invention may be realized in the image capturing device 100 in a form of a software or firmware program. That is, the program code for implementing the image resolution adjusting method of the present invention may be stored in the image capturing device 100, and then the processing unit 150 of the image capturing device 100 reads and executes the stored program code, so that the image capturing device 100 performs the image resolution adjusting method of the present invention.

The processing unit 150 may be implemented by one or more processors, for example, digital signal processors (DSPs). The storage unit 130 may be implemented by one or more storages. The storages may be non-volatile memories or volatile memories.

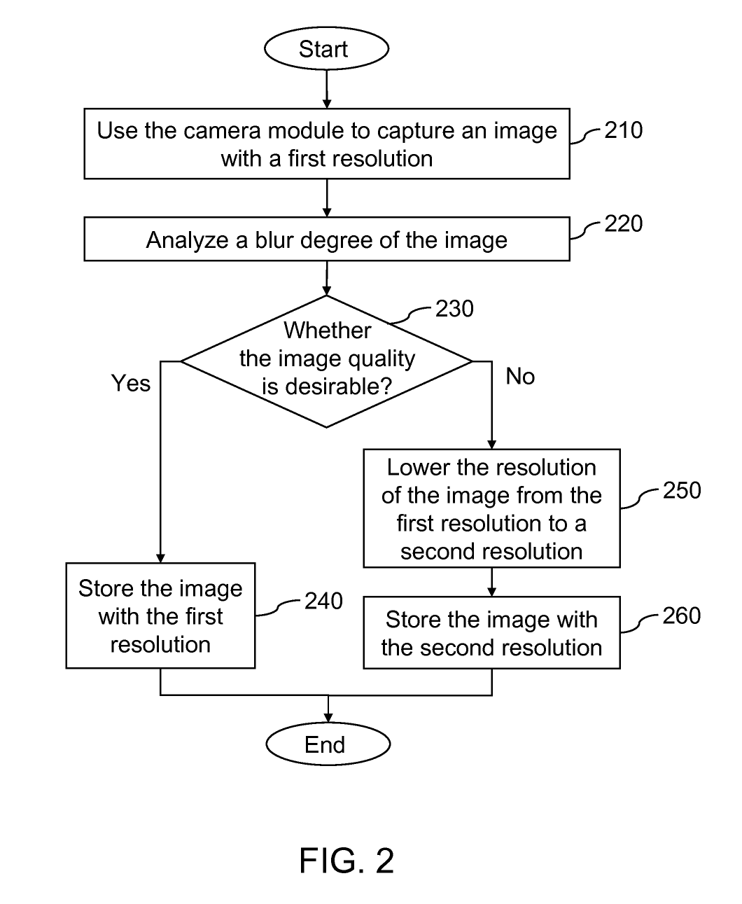

FIG. 2 is a flow chart of an image resolution adjusting method according to an embodiment of the present invention.

Referring to FIGS. 1 and 2, first, the camera module 110 captures an image corresponding to a plurality of subjects in front of the image capturing device 100 (Step 210). The image has a first resolution. The first resolution may be an image resolution currently set for the image capturing device 100 or an upper limit of the image resolution of the image capturing device 100 (the upper limit is determined by a capability of the image capturing device 100).

Next, a blur degree of the captured image is analyzed (Step 220). Here, the blur degree of the captured image is calculated through a blur detection procedure. In addition, a contrast value of the image may be calculated, which is then taken as a value of the blur degree of the image.

It is determined whether an image quality of the image is desirable by using the analyzed blur degree, that is, it is determined whether the blur degree satisfies a setting condition (Step 230).

When the image quality of the image is desirable, the image with the first resolution is directly stored in the storage unit 130 (Step 240).

When the image quality of the image is poor, the resolution of the image is lowered from the first resolution to the second resolution (Step 250) and then the image with the second resolution is stored in the storage unit 130 (Step 260).

Here, a threshold value or relation information (for example, a mapping table between the blur ranges and the resolution adjusting data) comprising a plurality of blur ranges and resolution adjusting data corresponding to the blur ranges is compared with the analyzed blur degree, thereby determining whether the image quality of the image is desirable.

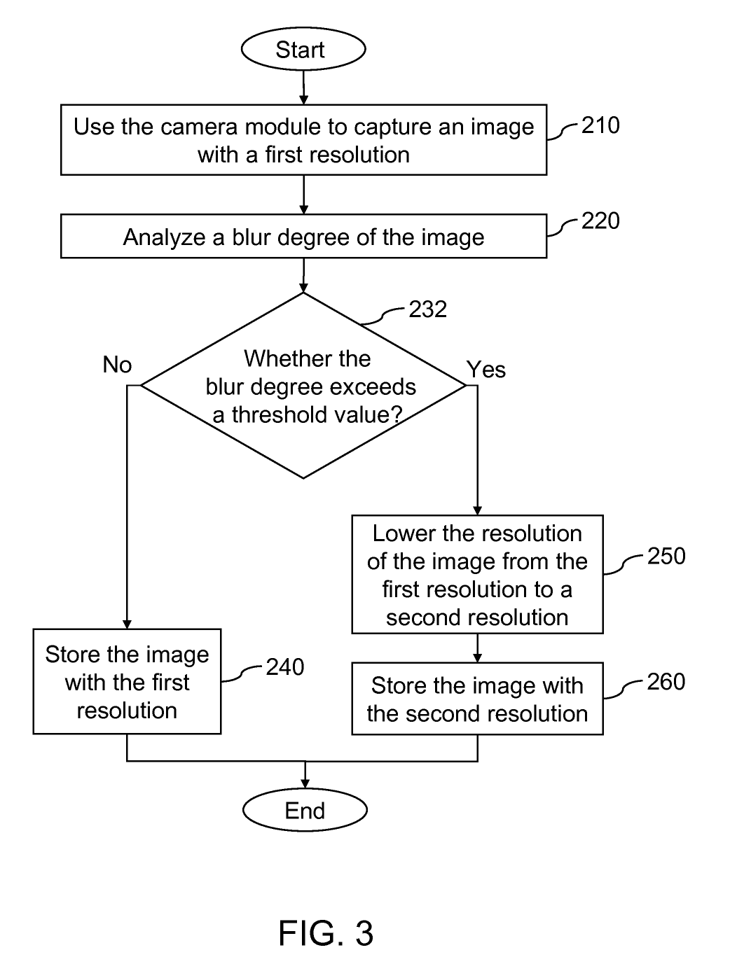

Referring to FIG. 3, the obtained blur degree is compared with a threshold value (Step 232).

When the blur degree exceeds the threshold value, it indicates that the image quality of the image is poor, so that the resolution of the image is lowered from the first resolution to the second resolution (Step 250), and then the image with the second resolution is stored in the storage unit 130 (Step 260).

In Step 250, when it is determined that the image quality of the image is poor, the current resolution of the image is lowered for a specific factor. In other words, the first resolution may be a specific multiple of the second resolution, for example, may be one time, twice, or more than triple as much as the second resolution.

For example, it is assumed that a current image resolution (that is, the first resolution) of the image capturing device 100 is set to 6 MP, and the specific factor is preset to one time. In this case, the image captured by the image capturing device 100 through the camera module 110 has a resolution of 6 MP. When the analyzing and determining result is that the image quality of the image is poor, the processing unit 150 performs a resolution adjusting procedure to lower the resolution of the image from 6 MP (that is, the first resolution) to 3 MP (that is, the second resolution).

In Step 250, according to a setting option of an image resolution of the image capturing device 100, the resolution of the image is lowered from the first resolution to the second resolution for a difference of a specific level. In other words, the first resolution is different from the second resolution for a specific level, for example, one level, two levels, or more than three levels.

For example, it is assumed that the setting option of the image resolution provided by the image capturing device 100 is 10 MP, 8 MP, 6 MP, 4 MP, 3 MP, 2 MP, and 1 MP, the current resolution (that is, the first resolution) is set to 8 MP, and the specific level is preset to one level. At this time, when it is determined that the image quality of the captured image is poor, the processing unit 150 performs a resolution adjusting procedure to lower the resolution of the image from 8 MP (that is, the first resolution) to 6 MP (that is, the second resolution).

On the contrary, when the blur degree does not exceed the threshold value, it indicates that the image quality of the image is desirable, so that the image with the first resolution is stored in the storage unit 130 (Step 240).

Here, the image capturing device 100 may additionally set that the adjusted resolution (that is, the second resolution) should be no less than a lower limit of the image resolution of the image capturing device 100 (the lower limit is determined by the capability of the image capturing device 100).

Moreover, the user may independently set a minimum value (that is, the second resolution) of the image resolution that can be adjusted according to the provided setting option of the image resolution.

When the preset value of the adjusted second resolution is smaller than the lower limit of the image resolution of the image capturing device 100 or the set minimum value of the image resolution that can be adjusted, the lower limit of the image resolution of the image capturing device 100 or the set minimum value of the image resolution that can be adjusted is directly taken as the value of the second resolution. In other words, if the preset value of the adjusted second resolution is smaller than the lower limit of the image resolution of the image capturing device 100 or the set minimum value of the image resolution that can be adjusted, the resolution of the image to be adjusted is lowered from the first resolution to the lower limit of the image resolution of the image capturing device 100 or the set minimum value of the image resolution that can be adjusted.

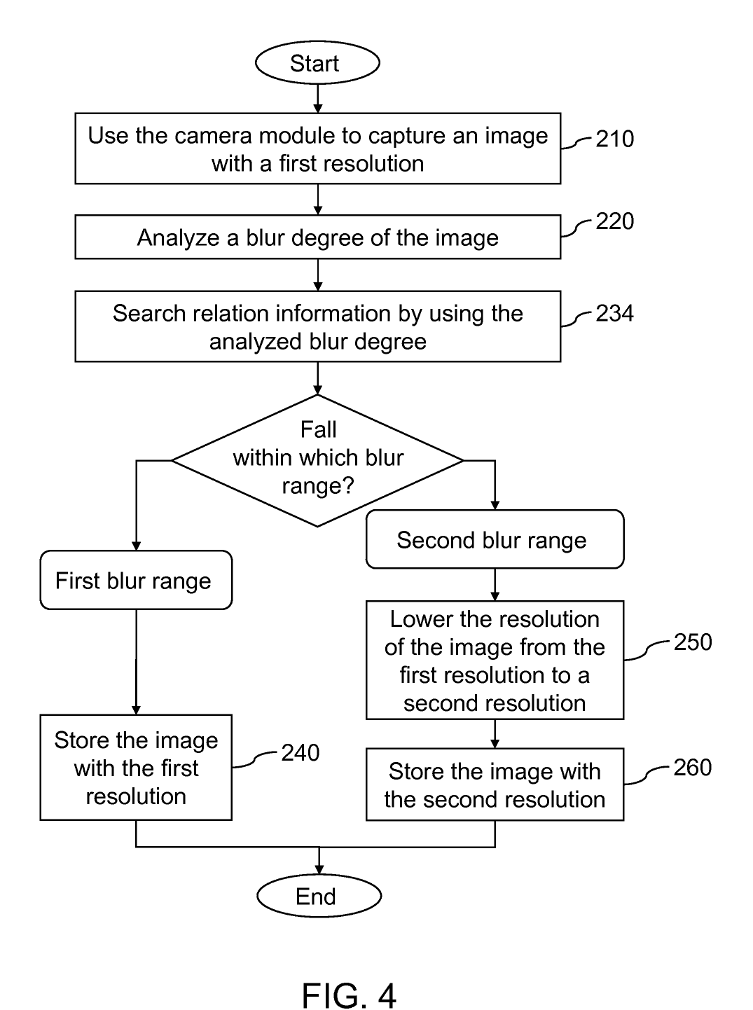

In addition, referring to FIG. 4, relation information is searched by using the analyzed blur degree (Step 234). The relation information comprises a first blur range, one or more second blur ranges different from one another, and resolution adjusting data respectively corresponding to the first blur range and the second blur ranges.

The first blur range indicates that the image quality of the image is desirable, and the second blur ranges indicate that the image quality of the image is poor. At this time, the resolution adjusting data corresponding to the first blur range indicates that no image adjustment is performed, that is, the image with the first resolution is stored in the storage unit 130. The resolution adjusting data corresponding to the second blur range indicates that an image resolution adjustment is performed to adjust the image from the first resolution to the second resolution. When a plurality of second blur ranges exists, the second blur ranges respectively indicate image qualities at different levels, and their corresponding resolution adjusting data indicate different adjusting results (that is, different values of the adjusted second resolution). In addition, the blur range may be a value or a status mark. The adjusting result may be a specific value, a specific factor, or a specific level (depending upon the setting option of the image resolution of the image capturing device 100).

When the analyzed blur degree is in the first blur range, no image resolution adjustment is performed according to the resolution adjusting data corresponding to the first blur range, and the image with the first resolution is stored in the storage unit 130 (Step 240).

When the analyzed blur degree is in one of the second blur ranges, the resolution of the image is lowered from the first resolution to the second resolution according to the resolution adjusting data corresponding to the second blur range (Step 250), and the image with the second resolution is stored in the storage unit 130 (Step 260). In other words, the second resolution matches the resolution adjusting data corresponding to the satisfied second blur range.

Here, when the preset value of the adjusted second resolution is smaller than the lower limit of the image resolution of the image capturing device 100 or the set minimum value of the image resolution that can be adjusted, the lower limit of the image resolution of the image capturing device 100 or the set minimum value of the image resolution that can be adjusted is directly taken as the value of the second resolution. In other words, if the preset value of the adjusted second resolution is smaller than the lower limit of the image resolution of the image capturing device 100 or the set minimum value of the image resolution that can be adjusted, the resolution of the image to be adjusted is lowered from the first resolution to the lower limit of the image resolution of the image capturing device 100 or the set minimum value of the image resolution that can be adjusted.

Two second blur ranges are taken as an example here for ease of description, and the relations between the first and second blur ranges and their corresponding resolution adjusting data are shown in the following Table 1. However, the present invention is not thus limited. Depending upon the actual demands, the second blur ranges may be one or more than three.

TABLE 1

| | Resolution adjusting |
|---|---|
| Blur range | data |
| First blur range | No adjustment |
| Second blur range | First adjusting result |
| A | |
| Second blur range | Second adjusting result |
| B | |

In other words, the relation information may be a mapping table of the blur ranges and the resolution adjusting data.

For example, the first blur range may be set to a range smaller than 40%, the second blur range A may be set to a range between 40% and 70%, and the second blur range B may be set to a range greater than 70%. In this case, the larger the number is, the more blurry the image will be, which, however, is not intended to limit the present invention. The first adjusting result may be set as being lowered for one level, and the second adjusting result may be set as being lowered for two levels.

It is assumed that the setting option of the image resolution provided by the image capturing device 100 is 10 MP, 8 MP, 6 MP, 4 MP, 3 MP, 2 MP, and 1 MP, and the current resolution (that is, the first resolution) is set to 8 MP.

When the analyzed blur degree is in the first blur range, no image resolution adjustment is performed according to the resolution adjusting data corresponding to the first blur range, and the image with the resolution of 8 MP is stored in the storage unit 130.

When the analyzed blur degree is in the second blur range A, the processing unit 150 performs a resolution adjusting procedure, lowers the resolution of the image from the resolution of 8 MP (that is, the first resolution) to a resolution of 6 MP (that is, the second resolution) according to the resolution adjusting data corresponding to the second blur range A, and stores the image with the resolution of 6 MP in the storage unit 130.

When the analyzed blur degree is in the second blur range B, the processing unit 150 performs the resolution adjusting procedure, lowers the resolution of the image from the resolution of 8 MP (that is, the first resolution) to a resolution of 4 MP (that is, the second resolution) according to the resolution adjusting data corresponding to the second blur range B, and stores the image with the resolution of 4 MP in the storage unit 130.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image resolution adjusting method, applicable to an image capturing device, wherein the image capturing device comprises a camera module and a storage unit, the image resolution adjusting method comprising:
capturing an image with a first resolution by the camera module;
analyzing a blur degree of the image;
comparing the blur degree with a threshold value;
when the blur degree exceeds the threshold value, lowering the resolution of the image from the first resolution to a second resolution, and storing the image with the second resolution in the storage unit; and
when the blur degree does not exceed the threshold value, storing the image with the first resolution in the storage unit.

2. The image resolution adjusting method according to claim 1, wherein the step of analyzing the blur degree of the image comprises: calculating the blur degree of the image through a blur detection procedure.

3. The image resolution adjusting method according to claim 1, wherein the step of analyzing the blur degree of the image comprises: calculating a contrast value of the image.

4. The image resolution adjusting method according to claim 1, wherein the first resolution is different from the second resolution for a specific factor.

5. The image resolution adjusting method according to claim 1, wherein in a setting option of a resolution of the image capturing device, the first resolution is different from the second resolution for a specific level.

6. An image resolution adjusting method, applicable to an image capturing device, wherein the image capturing device comprises a camera module and a storage unit, the image resolution adjusting method comprising:
capturing an image with a first resolution by the camera module;
analyzing a blur degree of the image;
searching relation information by using the analyzed blur degree, wherein the relation information comprises a first blur range, at least one second blur range different from one another, and resolution adjusting data respectively corresponding to the first blur range and the at least one second blur range;
when the blur degree is in the first blur range, storing the image with the first resolution in the storage unit according to the resolution adjusting data corresponding to the first blur range; and
when the blur degree is in one of the at least one second blur range, lowering the resolution of the image from the first resolution to a second resolution according to the resolution adjusting data corresponding to the second blur range which the blur degree is in, and storing the image with the second resolution in the storage unit.

7. The image resolution adjusting method according to claim 6, wherein the step of analyzing the blur degree of the image comprises: calculating the blur degree of the image through a blur detection procedure.

8. The image resolution adjusting method according to claim 6, wherein the step of analyzing the blur degree of the image comprises: calculating a contrast value of the image.

9. The image resolution adjusting method according to claim 6, the first resolution is different from the second resolution for a specific factor.

10. The image resolution adjusting method according to claim 6, wherein the first resolution and the second resolution are two resolutions different from each other for a specific level in a setting option of a resolution of the image capturing device.
